(19) United States
(12) Patent Application Publication
(10) Pub. No.: US 2018/0093308 A1
(43) Pub. Date: Apr. 5, 2018

(54) METHANOGENESIS CONTROL DURING ENVIRONMENTAL APPLICATIONS USING ANTIMETHANOGENIC REAGENTS

(71) Applicant: Innovative Environmental Technologies, Inc, Pipersville, PA (US)

(72) Inventors: James Mueller, Freeport, IL (US); Michael Scalzi, Doylestown, PA (US); Antonis Karachalios, Hatfield, PA (US)

(21) Appl. No.: 15/826,510

(22) Filed: Nov. 29, 2017

Related U.S. Application Data
(63) Continuation-in-part of application No. 15/408,145, filed on Jan. 17, 2017.
(60) Provisional application No. 62/279,519, filed on Jan. 15, 2016.
(60) Provisional application No. 62/497,712, filed on Nov. 29, 2016.

(51) Int. Cl. B09C 1/08; C02F 3/34; B09C 1/00

(52) U.S. Cl. CPC B09C 1/08; C02F 2101/32; B09C 1/002; C02F 3/34

(57) ABSTRACT

A method for controlling methanogenesis during environmental applications by inhibiting methane production of methanogens located in an environmental medium. The inhibiting of the critical biochemical pathways specific to the methanogens is achieved by providing one or more antimethanogenic reagent (AMR) compounds to the environmental medium. The AMR may include, for example, naturally-occurring statins (which may be found in red yeast rice), essential oils, certain synthetic compounds or combinations thereof. Limiting the methanogens in the environmental medium allows the slower-growing, halo-respiring bacteria that are utilized to dechlorinate containments to utilize the hydrogen donors (either naturally occurring or provided via fermentable substrates provided as part of a reduction process). The AMRs are harmless to the halo-respiring bacteria. The AMRs can be provided alone or along with various organic hydrogen donors, zero-valent iron (ZVI) or other reduced metals in order to enhance the biodegradation (reductive dechlorination) of targeted contaminants.

### PRIORITY

This application is a continuation-in-part (CIP) of, and claims priority to, U.S. application Ser. No. 15/408,145 filed on Jan. 17, 2017 which claimed the priority to U.S. Provisional Application 62/279,519 filed on Jan. 15, 2016. This application also claims priority to U.S. Provisional Application 62/497,712 filed on Nov. 29, 2016. Application Ser. No. 15/408,145; 62/279,519 and 62/497,712 are herein incorporated by reference in their entirety.

### BACKGROUND

Soil and groundwater at contaminated sites often contain chlorinated aliphatic hydrocarbons (CAHs) of anthropogenic origin such as tetrachloroethene (PCE), trichloroethene (TCE), carbon tetrachloride (CT), chloroform (CF) and methylene chloride (MC). In addition, (bio)degradation products, including dichloroethane (DCA), dichloroethene (DCE), and vinyl chloride (VC) can be present which represent additional hazards to public health and the environment. In addition, soil and groundwater at contaminated sites can contain (bio)degradation products, including for example dichloroethane (DCA), dichloroethene (DCE), vinyl chloride (VC), and various combinations thereof. The presence of these (bio)degradation products can represent additional hazards to public health and the environment.

In situations where remedial actions are warranted, in situ bioremediation-based processes often represent the most efficacious options, when applicable. The environmental biogeochemistry of each site largely determines the rate of biodegradation of CAHs observed. The initial catabolic reactions usually involve a biochemical process described as sequential biological reductive dechlorination. The occurrence of different types and concentrations of electron donors such as native organic matter, and electron acceptors such as oxygen and chlorinated solvents, determines to a large degree the extent to which reductive dechlorination occurs at a given site.

By definition, reductive dechlorination occurs in the absence of oxygen, with the chlorinated solvent substituting for oxygen in the physiology of the microorganisms carrying out the process. Based on thermodynamic considerations, reductive dechlorination will occur only after both oxygen and nitrate have been depleted from the aquifer since oxygen and nitrate are more energetically favorable electron acceptors than chlorinated solvents.

Multiple microorganisms, especially bacteria, will assist in removing oxygen and nitrates from the applied systems, and these biological processes often are used and manipulated to create the environmental conditions necessary for optimal destruction of the CAH contaminants. Bacteria generally are categorized by: 1) the means by which they derive energy, 2) the type of electron donors they require, or 3) the source of carbon that they require. Bacteria are classified further by the electron acceptor that they use, and therefore the type of zone that will dominate in the subsurface. A bacteria electron acceptor class causing a redox reaction generating relatively more energy, will dominate over a bacteria electron acceptor class causing a redox reaction generating relatively less energy.

Typically, bacteria that are involved in the biodegradation of CAHs in the subsurface are chemotrophs (bacteria that derive their energy from chemical redox reactions) and use organic compounds as electron donors and sources of organic carbon (organoheterotrophs). Heterotrophic bacteria are often used to consume dissolved oxygen, thereby reducing the redox potential in the ground water. In addition, as the bacteria grow on the organic particles, they ferment carbon and release a variety of volatile fatty acids (e.g., acetic, propionic, butyric), which diffuse from the site of fermentation into the ground water plume and serve as electron donors for other bacteria, including dehalogenators and halorespiring species.

Almost any substrate that can be fermented to hydrogen (H₂) can be used to enhance reductive dechlorination since these materials are used by dechlorinating microorganisms such as Dehalococcoides sp., Dehalobacter sp and numerous others. Laboratory studies have shown that a wide variety of organic substrates can serve as hydrogen donors (organic hydrogen donors) when they ferment to stimulate biological reductive dechlorination. These include acetate, propionate, butyrate, benzoate, glucose, lactate, methanol, and/or toluene. Inexpensive, more organically complex substrates such as molasses, cheese whey, corn steep liquor, corn oil, hydrogenated cottonseed oil beads, solid food shortening, beef tallow, melted corn oil margarine, coconut oil, soybean oil, and/or hydrogenated soybean oil and emulsifications thereof also have the potential to support reductive biological dechlorination by liberating hydrogen.

However, hydrogen is also a substrate for methanogenic bacteria that quickly convert the hydrogen into methane and remove it from the biochemical cycle. Methanogens typically thrive in environments in which all electron acceptors (e.g., oxygen, nitrate, trivalent iron, and sulfate) other than carbon dioxide (CO₂) have been depleted. As such, methanogens are often the dominant domain of microbe present in an aquifer (reducing environment). Notably, methanogens have significantly faster rates of growth and reproduction (e.g., >10×) as compared to known microbes with the ability to dehalogenate CAHs (e.g., Dehalococcoides sp).

By utilizing H₂, the methanogens compete with the dechlorinating microbes. Competition for H₂ is undesirable as this translates to additional cost during a remedial action as the generation and release of methane represents a waste of generated hydrogen. In addition, excessive methanogenesis under certain environmental settings can cause significant issues in terms of health and safety (e.g., methane is flammable; methane production can induce migration of CAHs yielding secondary in-door air issues). In addition, methane in the atmosphere is a significant contribution to greenhouse gasses.

While excessive methanogenesis has negative consequences, anaerobes live and function as synergistic communities of organisms, and methanogens play a critical role in the functioning of a healthy, vibrant system. While methanogens are desired, it would be beneficial to control the rate of growth, proliferation, and metabolism of methanogens that occurs within a reducing environment. The ability to control the rate of growth, proliferation, and metabolism of methanogenesis results in lower methane production, which positively affects numerous environmental aspects of concern, and also helps dehalogenating bacteria to more effectively utilize the environmental conditions (the available H₂) that promote reductive dechlorination of CAHs during in situ remediation. Furthermore, the amount of methane production will also be lowered.

### BRIEF DESCRIPTION OF THE DRAWINGS

The features and advantages of the various embodiments will become apparent from the following detailed description in which:

FIG. 1 illustrates a CO₂— CH₄ reduction pathway that occurs within methanogens.

FIG. 2 is a table that lists the volume of biogas production, pH values, and the concentrations of COD, ORP, and TDS measured in the Control and Test reactors during laboratory study one.

FIG. 3 is a table identifying the methane content measured in the biogas generated in the reactors during the 17-day study period of laboratory study one.

FIG. 4 is a graph of the methane concentrations listed in FIG. 3.

FIG. 5 is a table that lists the methane content measured in the biogas generated in the reactors during the 19-day study period of laboratory study two.

FIG. 6 is a table that defines the tests performed for different essential oils in laboratory study three.

FIGS. 7-9 are tables showing the results of the FIG. 6 tests for the 3 time intervals (day 3, day 7 and day 12 respectively).

FIG. 10 is a graph showing the results for the tests of FIG. 6 for the different time intervals.

FIG. 11 is a table of the methane concentration in the control and test samples for laboratory study four.

FIG. 12 is a graph of the methane concentrations listed in FIG. 11.

FIG. 13 is a table listing the concentration of chlorinated solvent PCE for each of the control and test samples of laboratory study four.

FIG. 14 is a graph showing the removal of PCE in the presence of the various AMRs.

### DETAILED DESCRIPTION

Biological methane formation is a microbial process catalyzed by methanogens. As used herein, the term methanogen refers to methane-producing organisms including both methane-producing bacteria and to Archaea (formerly classified as archaebacteria.) The methanogenic pathways of all species of methanogens have in common the conversion of a methyl group to methane; however the origin of the methyl group varies. Most species are capable of reducing carbon dioxide (CO₂) to a methyl group with either a molecular hydrogen (H₂) or formate as the reductant. Methane (CH₄) production pathways in methanogens that utilize CO₂ and H₂ involve specific methanogen enzymes, which catalyze unique reactions using unique coenzymes. The CH₄ production pathway is captured by the overall reaction noted below (reaction 1).

4H₂+CO₂→CH₄+2H₂O, with ΔG^{o′}=−130.4 kJ/mol (1)

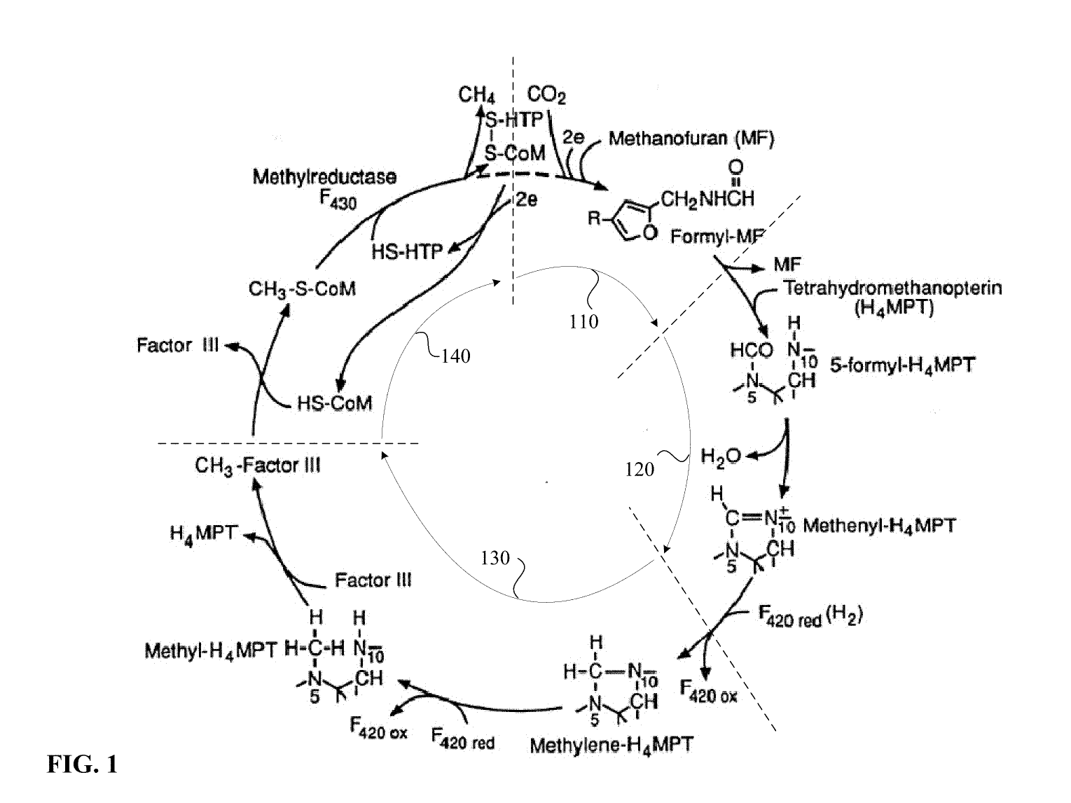

FIG. 1 illustrates a CO₂—CH₄ reduction pathway that occurs within methanogens 100. The reduction pathway 100 includes the following steps: carbon dioxide is reduced to the formyl level 110, the formyl group is reduced to the formaldehyde level 120, the methylene group is reduced to the methyl level 130, and the methyl group is converted to methane 140.

The reduction of CO₂ to the formyl level 110 is catalyzed by formyl-methanofuran dehydrogenase (FMF). FMF is the first stable intermediate in the pathway. Enzyme activity in the reverse direction is linked to the reduction of either methylviologen or coenzyme F₄₂₀ in all extracts of M. thermoautotrophicum strain.

Prior to the reduction of the formyl level to the formaldehyde level 120, the formyl group is transferred to 5,6,7,8-tetrahydromethanopterin (see reaction 2 below), and then converted to the methenyl derivative by the dehydrating cyclization (see reaction 3 below).

FMF+H₄MPT→5-Formyl-H₄MPT+2MF, with ΔG^{o′}=−4.4 kJ/mol (2)

5-Formyl-H₄MPT+H⁺→5,10-methenyl-H₄MPT⁺+H₂O, with ΔG^{o′}=−4.6 kJ/mol (3)

The 5,10-methenyl-H₄MPT⁺ is then reduced to the formaldehyde level with reduced coenzyme F₄₂₀ (see reaction 4 below).

5,10-methenyl-H₄MPT⁺+F₄₂₀H₂→5,10-methylene-H₄MPT+F₄₂₀+H⁺, with ΔG^{o′}=+6.5 kJ/mol (4)

Coenzyme F₄₂₀ is an obligate two-electron carrier as mentioned above (redox potential ˜−350 mV) that donates or accepts a hydride ion. The disappearance of the 5,10-methenylene-H₄MPT dehydrogenase activity results into increasing dependence on F₄₂₀ as an electron acceptor during the purification procedure or upon exposure to the air.

The reduction of the methylene group to the methyl level 130 includes the 5,10-methylene-H₄MPT reductase utilizing the reduced F₄₂₀ (F₄₂₀H₂) as the physiological electron donor (see reaction 5 below).

5,10-methylene-H₄MPT+F₄₂₀H₂→5-methyl-H₄MPT+F₄₂₀, with ΔG^{o′}=−5.2 kJ/mol (5)

Reaction 5 may proceed in either direction. However, the physiologically relevant methylene reduction is thermodynamically favored. Since H₂ is the source of electrons (see reaction 6 below), the reduction is exergonic and therefore could be associated with the generation of a primary electrochemical potential.

5,10-methylene-H₄MPT+H₂→5-methyl-H₄MPT, with ΔG^{o′}=−14 kJ/mol (6)

The conversion of the methyl group to methane 140 includes the transfer of the methyl group to Coenzyme M prior to the reduction (see reaction 7 below).

5-methyl-H₄MPT+HS-CoM→CH₃—S-CoM+H₄MPT, with ΔG^{o′}=−29.7 kJ/mol (7)

The CH₃—S-CoM methylreductase catalyzes (see reaction 8 below) and in the final reductive step of the reductive pathway CoM-S—S-HTP is reduced to the respective sulhydryl cofactors (see reaction 9 below).

CH₃—S-CoM+HS-HTP→CH₄+CoM-S—S-HTP, with ΔG^{o′}=−45 kJ/mol (8)

CoM-S—S-HTP+H₂→HS-CoM+HS-HTP, with ΔG^{o′}=−40 kJ/mol (9)

The various enzyme and co-enzyme systems include: i) 4-β-D-ribofuranosyl)aminobenzene-5′-phosphate (β-RFA-P) synthase, an early step in the biosynthesis of tetrahydromethanopterin (H₄MPT), which is a modified folate that is of central importance in growth and energy metabolism of methanogens; ii) Coenzyme F₄₂₀ (8-hydroxy-5-deazaflavin) NADP oxidoreductase enzyme which plays a vital role in the formation of methane; iii) Coenzyme M (CoM), 2-sulfanylethanesulfonate cofactor the substrate for the methylreductase which catalyzes the terminal step in all methanogenic pathways; iv) Coenzyme B, 2-[(7-mercapto-1-oxoheptyl)amino]-3-phosphonooxybutanoic acid, is the second substrate for methyl-coenzyme M reductase, and as a consequence of the reaction; and v) Coenzyme A 3-hydroxy-3-methylglutaryl coenzyme A (HMG-CoA) reductase, is an enzyme that is very critical in methane production in Methanobrevibactor strains, since Archaea are the only bacteria known to possess biosynthetic HMG-CoA reductase.

Antimethanogenic reagents (AMRs) are compounds designed to inhibit methane production in environments where methanogens are established and active. It is believed that AMRs could inhibit the methane production within a reducing environment (control the rate of growth, proliferation, and metabolism of methanogens). The ability to control methanogenesis results in lower methane production and also helps dehalogenating bacteria to more effectively utilize the environmental conditions (the available H₂) that promote reductive dechlorination of CAHs during in situ remediation.

AMRs may include one or more unique compounds that either alone or in combination with one another effect the production of methane. Statins are believed to be an AMR. Red yeast rice provides a naturally occurring statin and therefore is believed to be an AMR. In order to determine the effectiveness of red yeast rice for inhibiting methane, two bench scale studies were performed.

Laboratory Study 1

Two anaerobic reactors were utilized, a control and a test reactor. The two reactors were seeded with biomass treating expired dietary supplement, which contained an active methanogenic population. The reactors were fed once per week, and were operated as anaerobic sequencing batch reactors.

During the first week of startup, the reactors contained only the methanogenic culture, without soil. After one week, silty sand was added, resulting in a slurry having a solids concentration of 20% by weight. The reactors were operated for another week with the silty sand, to ensure that the sand did not affect methanogenic activity. The bioreactors were 2.5 L in volume, containing 2 L of slurry. The reactors were airtight and were especially designed for anaerobic reactions. The reactors were maintained at laboratory temperature 22° C.-24° C. The reactors were operated by feeding with dietary supplement once a week. The target initial chemical oxidation demand (“COD”) concentration after feeding was 2000 mg/L.

Throughout the week, the volume of biogas produced was measured as follows. A syringe was inserted periodically into a septum-filled port in the top of the reactor to collect a gas sample for methane content. The methane content of the biogas samples was then quantified by injecting into a gas chromatograph with a flame ionization detector (GC-FID). The reactors had dedicated probes to measure pH and oxidation reduction potential (“ORP”). After each cycle (i.e., before feeding), a probe was inserted into the reactor to measure total dissolved solids (“TDS”), and a sample was collected to measure COD. The mixer was turned off during sampling and feeding to minimize the introduction of oxygen into the reactor contents.

The test reactor was initially dosed with a 40 g/L concentration of red yeast rice. One week later the control was dosed with 20 mg/L red yeast rice.

Results for Laboratory Study 1

The first two weeks of the studies were the startup period, and the second two weeks were the test period. The startup period established the methanogenic population in the two reactors. During the first week of startup, the reactors were operated without the silty sand, and the second week they were operated with the silty sand (20% by weight). The test period started with the dosing of the test reactor with red yeast rice (40 g/L). During the first week of the test period the control was maintained as a proper control, with no red yeast rice added. Because the 40 mg/L dose of red yeast rice reduced methane production in the test reactor, it was decided to dose the control reactor with 20 g/L of red yeast rice during the second week of the test period. The test period lasted 17 days.

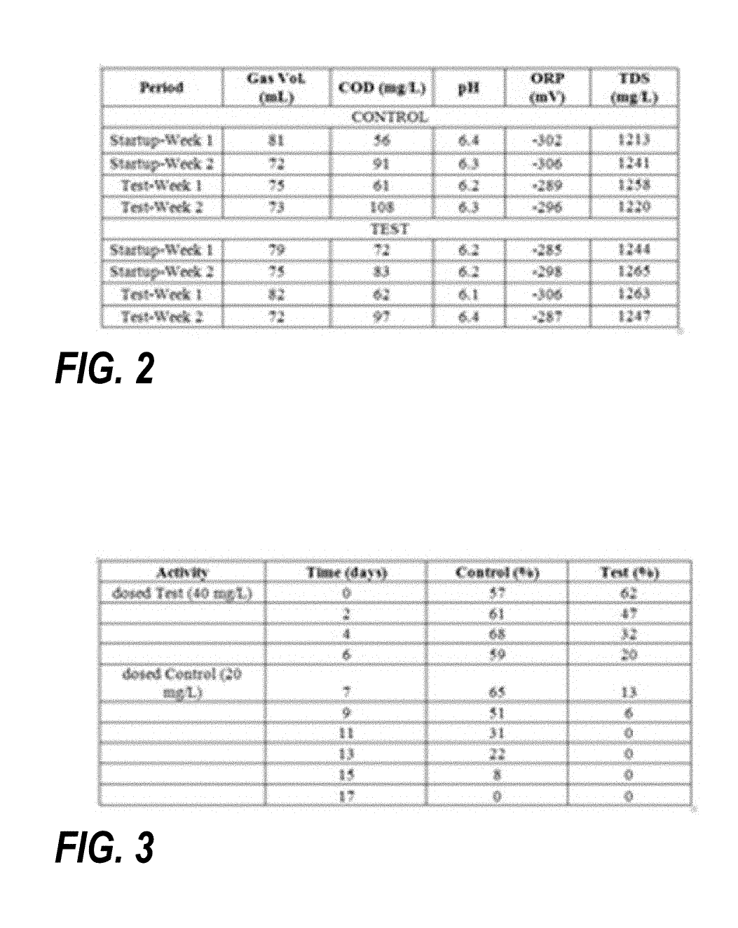

FIG. 2 is a table that lists the volume of biogas production, concentrations of COD, pH values, and the concentrations of ORP and TDS measured in the control and test reactors during the studies. The volume of biogas produced each feed cycle (i.e., each week) in the reactors ranged between 72-82 mL. It is notable that the volume of gas was not affected by the introduction of silty sand during week 2 of the startup period. The addition of 40 mg/L of red yeast rice to the test in the first week of the test period and the addition of 20 mg/L of red yeast rice during the second week of the test period did not appreciably impact biogas volume in the reactors. The COD measurements after each sequencing batch reactor cycle ranged from 56 to 108 mg/L. The reactors were fed 2000 mg/L each cycle, so the COD concentrations demonstrate that the COD was consumed by the anaerobic culture. Values of pH ranged between 6.1 and 6.4. Values of ORP were all close to −300 mV, which is typical of methanogenic conditions. The TDS in the reactors ranged from approximately 1200 to 1250 mg/L.

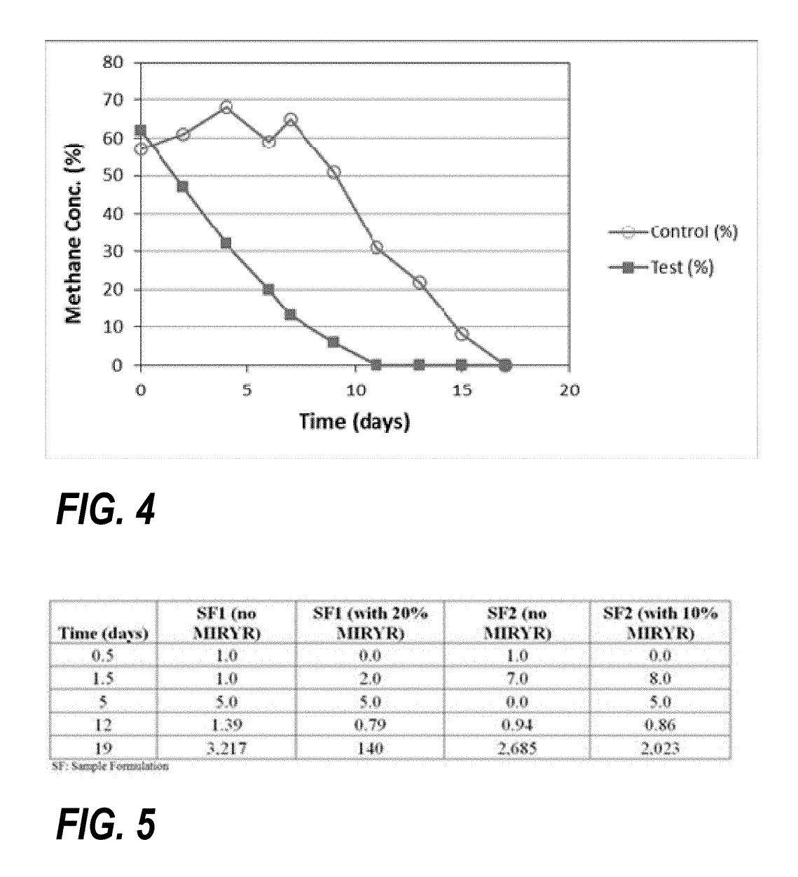

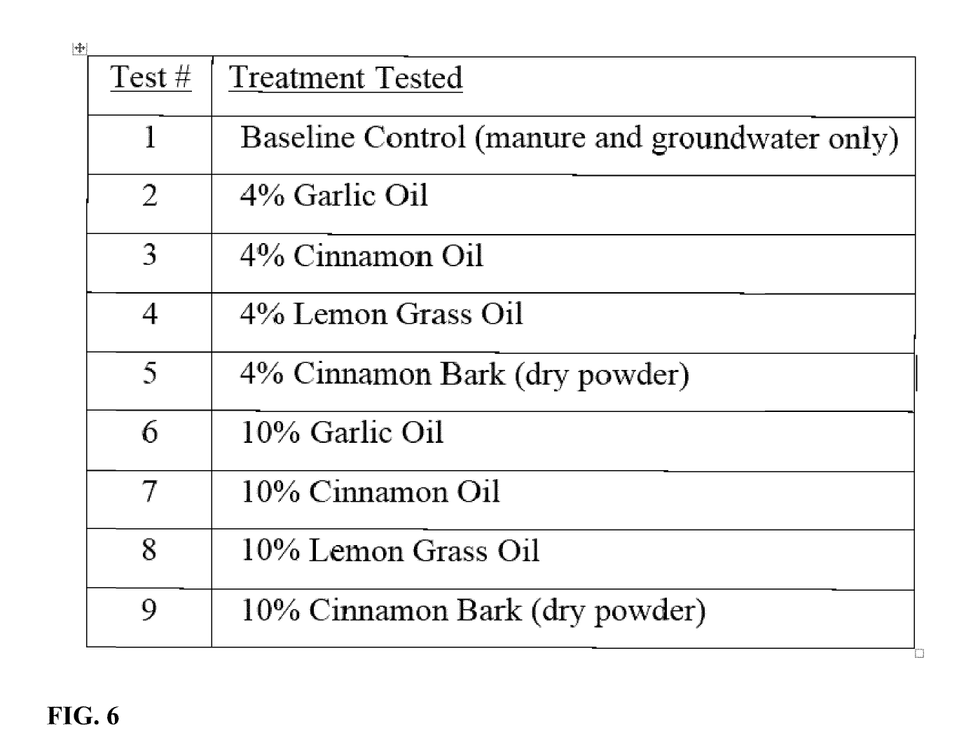

FIG. 3 is a table and FIG. 4 is a graph of the methane content measured in the biogas generated in the reactors during the 17-day test period. While not captured in FIG. 3 or 4, during the Startup Period, methane concentrations varied from approximately 55% to 70%, which indicates an active methanogenic culture. The red yeast rice dose of 40 mg/L in the Test reactor reduced the methane content of biogas from 62% to below detection (0.05%) after 11 days. The methane concentration remained below detect in the Test reactor until day 17, when the reactors were dismantled. The red yeast rice dose of 20 mg/L in the Control reactor on day 7 reduced the methane content of biogas from 65% to below detection (0.05%) by day 17 (i.e., after 10 days). During the Test period, the volume of biogas produced in the Test and Control reactors did not change appreciably only the methane concentration of the biogas was changed.

Laboratory Study 2

Two test aliquots were prepared under a nitrogen atmosphere in a glove box as follows: (1) a 240 mL amber glass screw-cap septum bottle was filled with 100 g of dry soil (˜70 mL); (2) deoxygenated deionized water was slowly added to the soil to saturate the soil; an additional 40 mL of water was then added to the soil; and (3) manure slurry was added to yield a 1 weight percent manure dose to the soil.

Once the bottle was sealed it was removed from the glove box. The soil was kept in the dark (by wrapping with foil) at room temperature (˜22° C.). A needle connected to a polyethylene tube was pushed through the bottle septum and the tube outlet was placed in an inverted graduated cylinder in a water bath. The gas generation rate was recorded as the water was displaced over a period of 10 days.

The methane reduction trial included two sample formulations, with and without red yeast rice, for a total of 4 samples. The bottles were sampled 0.5, 1.5, 5, 12, and 19 days following the sample preparation.

Results for Laboratory Study 2

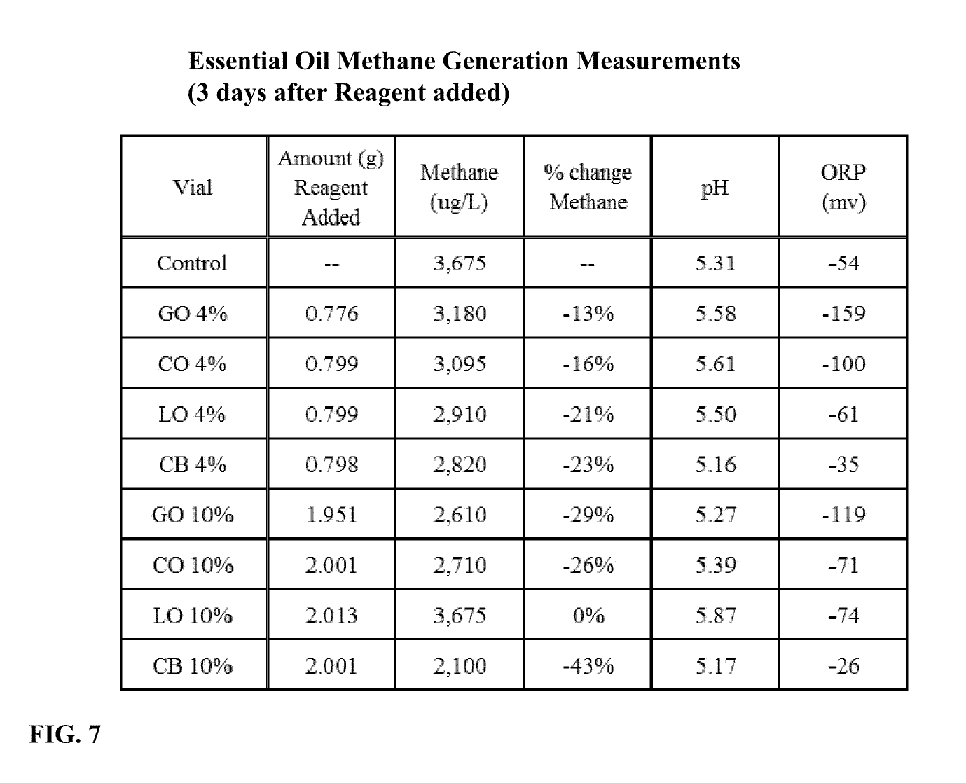

FIG. 5 is a table that lists the methane content measured in the biogas generated in the reactors during the 19-day study period. The first soil formulation (SF1) without red yeast rice measured a methane content of 3,217 after 19 days compared to the SF1 that contains 20% red yeast rice (approximately 40 mg/L in solution) which measured a methane content of 140. The 20% red yeast compound showed great effectiveness in inhibiting the methane production by 96% during the 19-day sampling interval. Similarly, the second soil formulation (SF2) with 10% red yeast rice resulted into a 25% decrease in methane production compared to SF2 without red yeast rice (reduced from 2,685 to 2,023).

The above tests clearly illustrate the effectiveness of red yeast rice in inhibiting methane. Utilizing organic statins (some of which can be present in red yeast rice extract as well as biomass of other organisms) may inhibit the methanogenic enzyme and coenzyme systems essential to the growth and development of methanogens.

Essential oils and/or saponins are also believed to be AMRs. Essential oils are mixtures of aromatic chemicals present in plant material such as leaves, buds, flowers, fruit, bark, root, or wood, and are comprised of various terpenes, acids, aldehydes, alcohols, esters, and ketones. Nearly all essential oils are obtained by physical means, with most essential oils obtained by the process of steam distillation of plant materials. There are a few essential oils obtained using chemical solvent extractions. These products are termed “concretes” and “absolutes”. They are used in perfumes, cosmetics, soaps and other products, for flavoring food and drink, and for adding scents to incense and household cleaning products.

Saponins are glucosides with foaming characteristics. They consist of a polycyclic aglycones attached to one or more sugar side chains. The aglycone part, which is also called sapogenin, is either steroid (C27) or a triterpene (C30). The foaming ability of saponins is caused by the combination of a hydrophobic (fat-soluble) sapogenin and a hydrophilic (water-soluble) sugar part. Saponins have a bitter taste. Some saponins are toxic and are known as sapotoxin.

The essential oils/saponins utilized to disrupt the enzyme and coenzyme systems in order to limit the methanogenesis process may include, but are not limited to, garlic oil (Allium sativum), lemongrass oil (Cymbopogon citratus), clove oil (Syzgium aromaticum) and/or cinnamon bark oil (Cinnamomum zeylanicum).

At a wide range of concentrations the essential oils/saponins are typically found to be harmless to most other bacteria that may be present in the environment (e.g., an aquifer system). Accordingly, this positively affects the ability of slower-growing, halo-respiring bacteria to compete with methanogens for the hydrogen donors that are present in the environment (having reducing conditions).

Laboratory studies were performed to comparatively evaluate the antimethanogenic potential of multiple essential oils (e.g., Garlic Oil [GO], Cinnamon Bark Oil [CO], Cinnamon Bark Powder containing 4% CO [CB] and lemongrass Oil [LO]).

Laboratory Study 3

Manure and groundwater samples were collected from a site in Monticello, Wis. at 1:1 ratio. The collected samples were added to 125 mL amber glass bottles equipped with PTFE-lined open septum caps (VOA vials). The testing program included 40 vials each filled with 20 g manure slurry and 20 g groundwater. All samples were sacrificial and disposed after completion of the analyses. Five (5) vials were used to indicate the onset of anaerobic conditions by measuring pH, ORP and methane over a 2-week period.

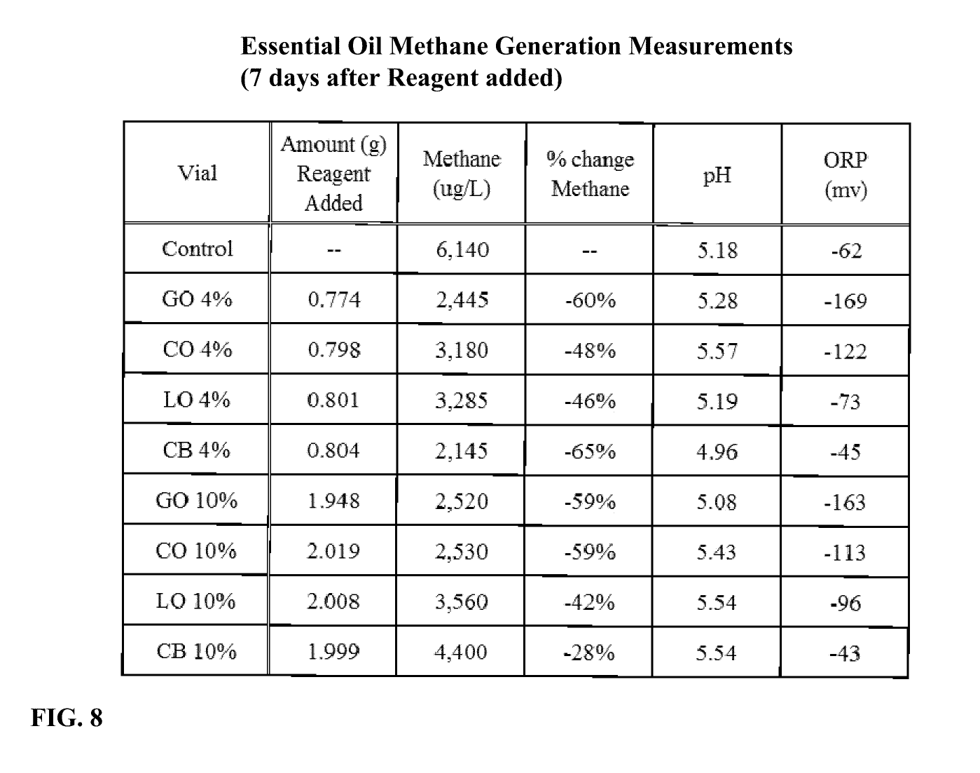

FIG. 6 is a table that defines the tests performed. A total of 27 vials were prepared to analyze the 9 tests defined in FIG. 6 over 3 time intervals (day 3, day 7, day 12). Finally 8 vials were setup as replicate samples.

Gas samples from the sample container headspace were analyzed for methane in the gas phase using a gas chromatograph (GC) with a flame ionization detector (FID). After these analyses were completed, pH and ORP were also measured.

Results for Laboratory Study 3

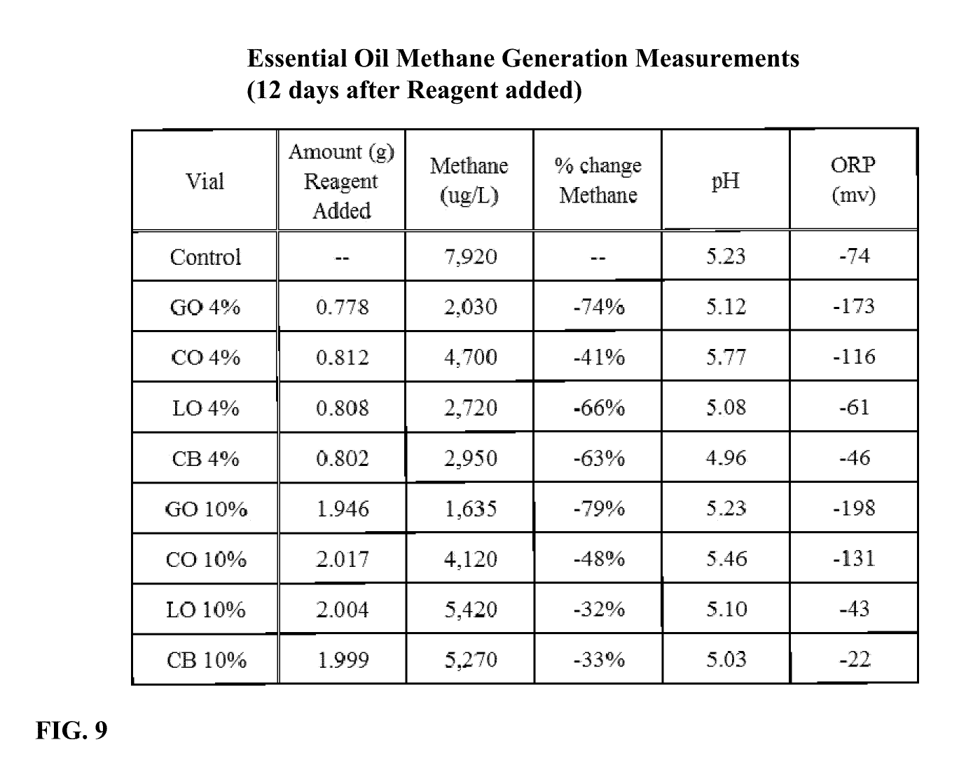

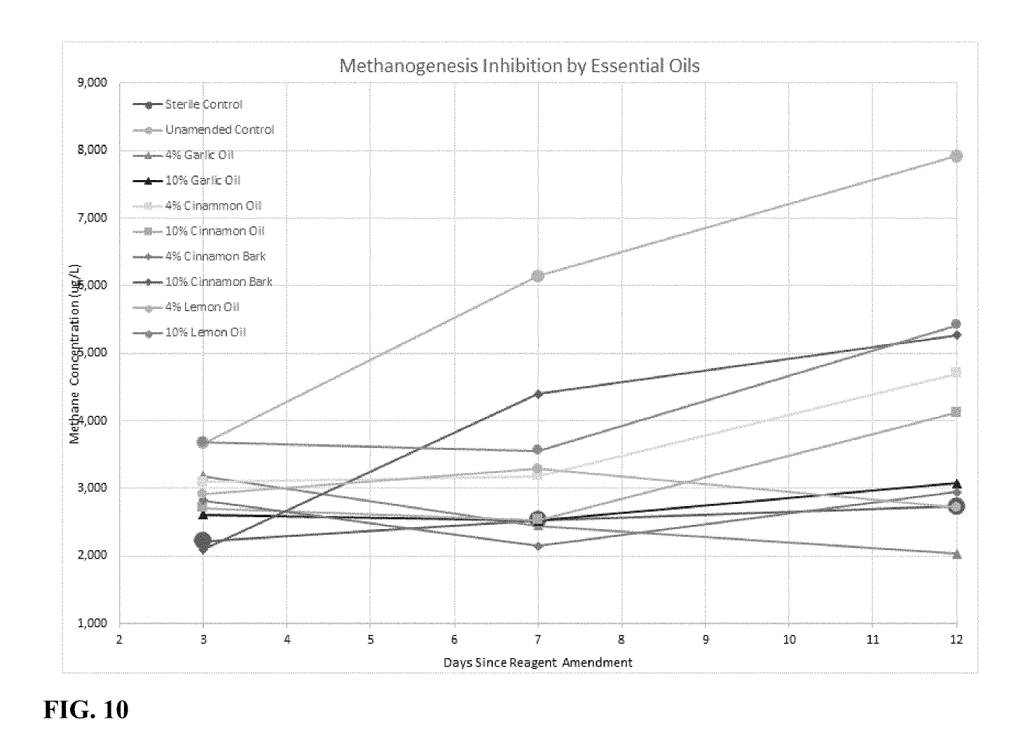

FIGS. 7-9 are tables showing the results of the 9 tests for the 3 time intervals (day 3, day 7 and day 12 respectively). FIG. 10 is a graph showing the results for all the tests for the different time intervals. As illustrated, it is apparent that all essential oils were successful in decreasing the amount of methane produced, with the Garlic Oil appearing to be the most effective of all.

Saponins, essential plant oils, and/or naturally occurring statins (e.g., such as those found in red yeast rice) however, can be challenging to process, can have limited longevity in the field, have a specified mode of action, and they can be prohibitively expensive.

Certain synthetic compounds also believed to be AMRs. The synthetic compounds may be quicker, easier and cheaper to produce and may have a different mode of operation than other AMRs. For example, diallyl disulfide, diallyl trisulfide, and ethyl propionate are believed to interfere with the biosynthesis of psuedomurein by symbiont Archaea (methanogens).

Diallyl disulfide has a chemical formula C₆H₁₀S₂ and is also known as garlicin. Garlicin is produced from sodium disulfide and allyl bromide or allyl chloride at temperatures of about 40-60° C. in an inert gas atmosphere as indicated in the below reaction.

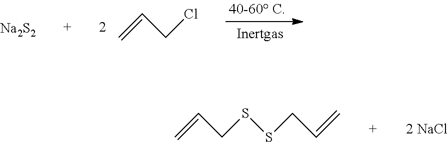

The sodium disulfide is generated in situ by reacting sodium sulfide with sulfur. The reaction is exothermic and its theoretical efficiency of 88% has been achieved.

Diallyl trisulfide has a chemical formula S(SCH₂CH═CH₂)₂ and is also known as allitridin. Allitridin is produced in a similar manner to garlicin and has the below structural formula.

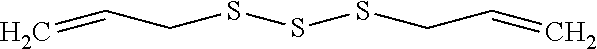

Ethyl propionate is an ethyl ester of propionic acid and has a chemical formula C₂H₅(C₂H₅COO) and the below structural formula.

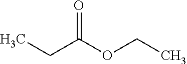

The synthetic compounds may in part control Archaea via interference with psuedomurein production, which is a protein unique to a methanogen and is critical to its long term viability and function. This mode of action differs from other reported means of controlling methanogenesis, and therefore represents an improved method when used alone or in conjunction with other processes. Expanded control mechanisms can offer improvements in longevity and overall efficacy of controlled methanogenesis.

Laboratory Study 4

Use of diallyl sulfide, which may be considered a synthetic garlic oil (GOS), was evaluated for its ability to control Archaea compared to the effects of other potential AMRs such as natural/pressed Garlic Oil (GO) and dehydrated Garlic Powder (GP). Control samples with and without contaminants were captured along with test samples that included contaminants and different concentrations (250 ppm and 500 ppm) of different AMRs (GO, GOS and GP). The concentration of methane in each of the samples was measured at 0, 9, 16 and 23 days.

Results of Laboratory Study 4

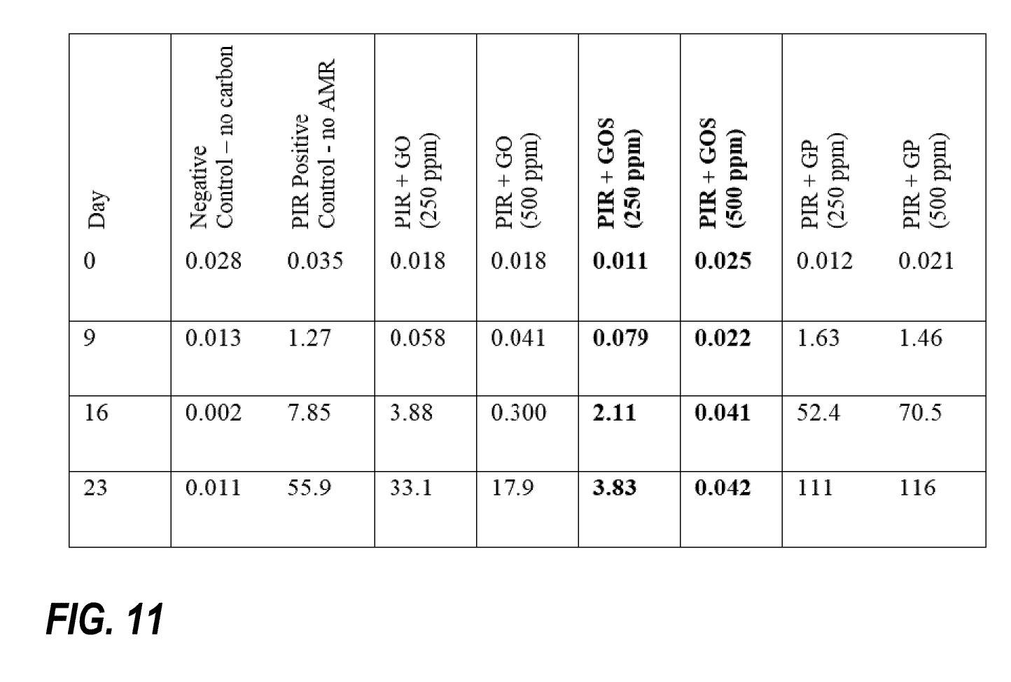

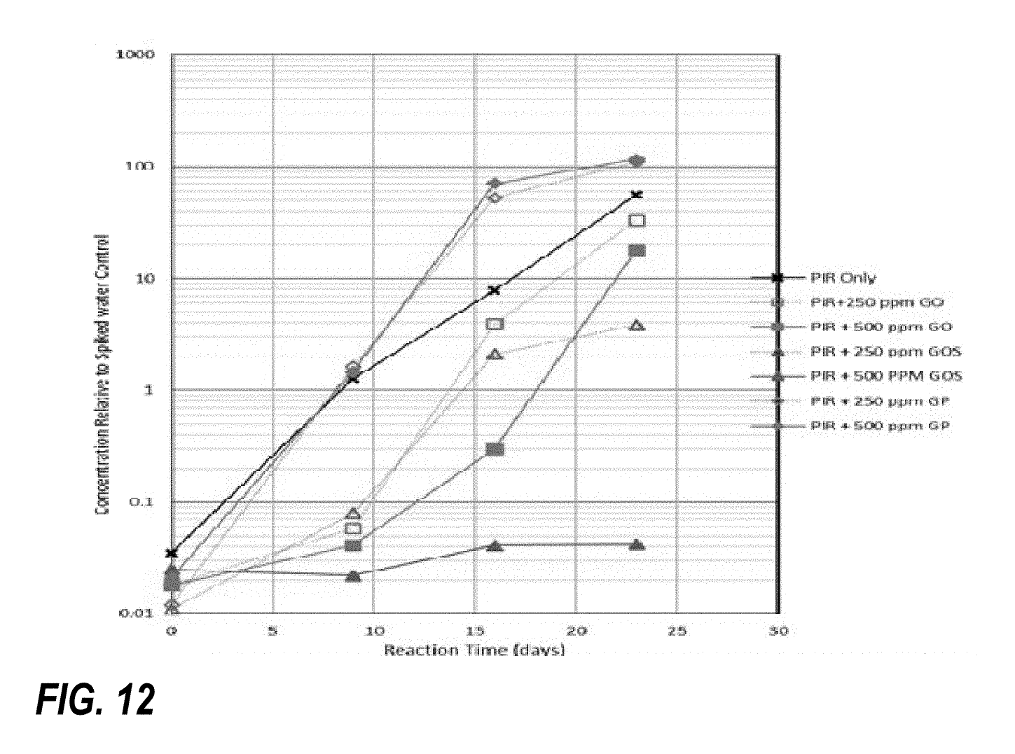

FIG. 11 is a table and FIG. 12 is a graph of the methane concentration in the control and test samples. After 23 days incubation under laboratory conditions, the presence of GOS yielded the best control response in terms of methane production. Natural pressed GO also exhibited the preferred antimethanogenic response, at least through the initial incubation period. The length and magnitude of antimethanogenic responses for both the GO and GOS were concentration dependent with the higher (i.e., 500 ppm) application rates lasting longer than the lower (i.e., 250 ppm) dosage. The amount of methane produced in the presence of dehydrated GP was the same as that in the positive control test system. The absence of antimethanogenic activity with the GP is presumably due to the loss of volatile diallyl sulfides (which are the active ingredients in the GOS) during the production process.

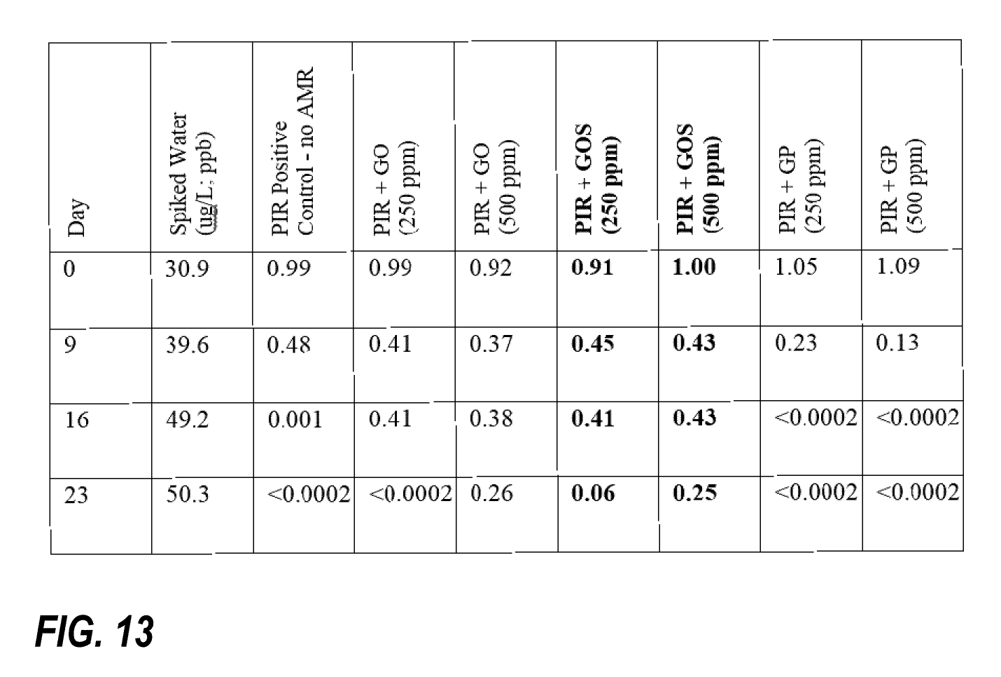

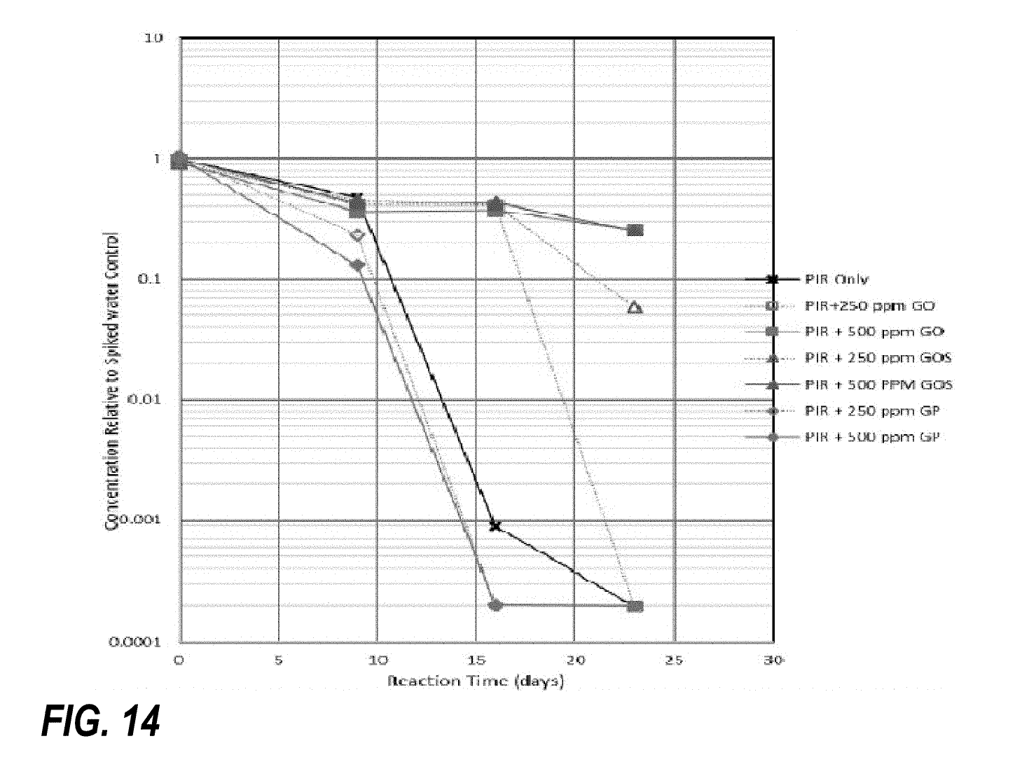

FIG. 13 is a table listing the concentration of chlorinated solvent PCE (C/Co; ug/L) in water for each of the control and test samples. FIG. 14 is a graph showing the removal of PCE in the presence of the various AMRs. None of the AMRs tested had a detrimental effect on the desired process of contaminant biodegradation. However, the antimethanogenic responses for both the GO and GOS at the higher (500 ppm) application rates correlated with lower rates of removal of targeted contaminants.

The introduction of the AMRs in the subsurface can be achieved through various applications. These applications can be utilized in order to inject the AMRs either via pumping processes as a liquid or through an induced gas stream. The main applications used to provide the AMRs into an environment medium include direct-push injection (DPI) methods, injection well (IW) methods, hydraulic and pneumatic fracturing injection methods.

DPI methods rely on the hydraulic downward advancement of hollow steel rods into the target zone and the displacement of soil and groundwater around the diameter of rod tip. Soil displacement via the DPI rods creates localized areas of compaction immediately around the injection rods. Once the DPI point is installed pressure is applied to inject a slurry of remedial material in the subsurface.

Injection wells are typically used in order to gravity feed the remedial material in an aquifer. Most Injection wells are commonly constructed of polyvinylchloride (PVC) or stainless steel pipe and are usually made with the intention of being temporary or semi-permanent. More permanent type wells such as monitoring wells or pumping wells can also be used for injection purposes.

Pneumatic fracturing uses a gas to fracture the media and inject the remedial material, with or without the use of packers to isolate the injection depth. The pneumatic fracturing is used to create or enhance subsurface fractures with controlled bursts of high-pressure gas at pressures exceeding the natural in situ geostatic pressures and at flow volumes exceeding the natural permeability of the subsurface.

The AMRs can be provided in various combinations, strategies, preparations and formulations. Individual AMRs may be applied or a combination of AMRs may be applied either together or sequentially. The AMRs can be injected alone or along with various organic hydrogen donors, zero-valent metals such as zero valent iron (ZVI), other reduced metals (e.g., divalent iron, reduced zinc, reduced palladium) or surfactants in order to enhance the biodegradation of the targeted contaminants (support desired biological reductive dechlorination reactions while controlling the production of methane during remedial actions, and in other environmental applications). The AMRs may be amenable to co-application with other hydrophobic organic hydrogen donors, and they can be applied in conjunction with a myriad of other fermentable carbon sources.

If the AMRs are provided along with other materials (e.g., organic hydrogen donors, ZVI), the AMRs may be provided concurrently or sequentially (before or after) to the other materials.

The amount of AMRs required to control methanogenesis in an environmental medium may depend on various parameters including the type of environmental medium, the amount of methane being produced, whether contaminants are present in the environmental medium and if so what the containments are and at what levels, if any other materials (e.g., organic hydrogen donors, ZVI) are being provided to the environmental medium to reduce the contaminants, and what the time frame is for biological remediation of the contaminants. According to one embodiment, the essential oils/saponins may be provided at dosages of between approximately 4% and 10% of the ground water concentration of the environmental medium.

Various fermentable substrates (e.g., liquid, solid, fibrous, emulsified) may be provided to the environmental medium to act as an organic hydrogen donor in order to provide additional H₂ to be utilized by the dehalogenating bacteria during reductive dechlorination of CAHs during in situ remediation processes. The fermentable substrate may be provided to the environment medium along with the AMR(s) either concurrently or in any sequential order. By way of example, some useful fermentable substrates include, but are not limited to carbohydrates including glucose and glucose-producing compounds; acetate; propionate; butyrate; benzoate; lactate; formate; methanol; toluene; molasses; cheese whey; corn steep liquor; oils including corn oil, peanut oil, coconut oil, vegetable oil, fish oil, soybean oil, hydrogenated cottonseed oil beads; solid food shortening, beef tallow; melted corn oil margarine; filamentous plant material; chitin and hydrogenated soybean. Inorganic hydrogen sources such as zero valent iron can also liberate hydrogen to drive the desired biological reactions and are also included herein.

The amount and type of organic hydrogen donor utilized to support biological remediation in an environmental medium may depend on various parameters including the type of environmental medium, what the containments are present therein and at what levels, and how long the desired reduction period is. For example, applications where remediation is required over a longer period of time may utilize organic hydrogen donors that ferment over longer periods of time so that H₂ is available to be utilized by the dehalogenating bacteria over a longer period of time. The activity of methanogens within the reducing environment that compete for the available H₂ is also a consideration in the amount and type of organic hydrogen donor utilized. In summary, the amount and type of organic hydrogen donor utilized is specific to each remediation project.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

What is claimed is:

1. A method for inhibiting methane production in an environmental medium, the method comprising providing an antimethanogenic reagent (AMR) to the environmental medium, wherein the AMR inhibits methane production of indigenous symbiotic methanogens located in the environmental medium.

2. The method of claim 1, wherein the environmental medium is soil, sediment, water in ground water.

3. The method of claim 1, wherein the environmental medium is subject to reductive dechlorination.

4. The method of claim 1, wherein the AMR is a synthetic compound.

5. The method of claim 4, wherein the synthetic compound includes diallyl disulfide.

6. The method of claim 4, wherein the synthetic compound includes diallyl trisulfide.

7. The method of claim 4, wherein the synthetic compound includes ethyl propionate.

8. The method of claim 4, wherein the synthetic compound includes diallyl disulfide, diallyl trisulfide, ethyl propionate or combinations thereof.

9. The method of claim 1, where the AMR includes an essential oil.

10. The method of claim 9, wherein the essential oil includes garlic oil, lemongrass oil, cinnamon bark oil, cinnamon bark powder or some combination thereof.

11. The method of claim 1, wherein the AMR includes any combinations of ingredients selected from synthetic compounds, naturally occurring statins and essential oils.

12. The method of claim 1, wherein the AMR disrupts enzyme and coenzyme systems that are integral parts of a methanogenesis process of the methanogens.

13. The method of claim 1, wherein the AMR interferes with biosynthesis of psuedomurein by the indigenous symbiotic methanogens.

14. The method of claim 1, further comprising providing a fermentable substrate to the environmental medium to provide an organic hydrogen donor.

15. The method of claim 14, wherein the providing the AMR and the providing the fermentable substrate are done concurrently as a combination.

16. The method of claim 14, wherein the providing the AMR and the providing the fermentable substrate are done sequentially.

17. The method of claim 14, wherein the fermentable substrate includes at least some combination of acetate, propionate, butyrate, benzoate, lactate, formate, methanol, toluene, molasses, cheese whey, corn steep liquor, corn oil, peanut oil, coconut oil, vegetable oil, fish oil, soybean oil, hydrogenated cottonseed oil beads, solid food shortening, beef tallow, melted corn oil margarine, filamentous plant material, chitin and hydrogenated soybean.

18. The method of claim 14, wherein the fermentable substrate is a carbohydrate including a glucose, a glucose-producing compound or a combination thereof.

19. The method of claim 1, further comprising providing zero valent iron or other reduced metals into the environmental medium.

20. The method of claim 1, wherein the providing the AMR includes injecting the AMR into the environmental medium.
